(19) United States
(12) Patent Application Publication
(10) Pub. No.: US 2015/0294235 A1
(43) Pub. Date: Oct. 15, 2015

(54) ELECTRONIC MISCELLANEOUS DOCUMENT HANDLING IN RESPONSE TO INVOLUNTARY MODIFICATIONS OF ANCILLARY SERVICES

(71) Applicant: Amadeus S.A.S., Sophia Antipolis (FR)

(72) Inventors: Anatole Laffitte, Mouans Sartoux (FR); Bertrand Alberola, Pegomas (FR); Manuela Argano, Antibes (FR); Caroline Pellegrin, Mouans Sartoux (FR); Garnier Ngando, Nice (FR)

(73) Assignee: Amadeus S.A.S., Sophia Antipolis (FR)

(21) Appl. No.: 14/252,799

(22) Filed: Apr. 15, 2014

(51) Int. Cl. G06Q 10/02; G06Q 50/14; G06F 17/30

(52) U.S. Cl. CPC G06Q 10/02; G06F 17/30011; G06F 17/30876; G06Q 50/14

(57) ABSTRACT

Methods, systems, and computer program products for handling electronic miscellaneous documents in response to involuntary modifications of services. A request, which includes first data for a passenger name record, is received for a change to an airline reservation. Second data for an electronic miscellaneous document that is linked to the first data for the passenger name record is also received. A determination is made as to whether the electronic miscellaneous document can be exchanged by applying at least one exchange eligibility rule to the first data for the passenger name record and the second data for the electronic miscellaneous document. If the electronic miscellaneous document can be exchanged, an exchange of the electronic miscellaneous document is automatically processed.

### BACKGROUND

The invention generally relates to computers and computer software and, in particular to methods, systems, and computer program products for handling electronic miscellaneous documents in response to involuntary modifications of services.

Electronic miscellaneous documents (EMDs) are issued for travel-related services, including unbundled airline services. Generally, two distinct types of electronic miscellaneous documents may be issued. A standalone electronic miscellaneous document (EMD-S) is not issued in conjunction with a standard flight ticket. A standalone electronic miscellaneous document can be issued for a non-flight ancillary service, such as a car rental voucher or lounge access, but is not associated to a flight coupon. An associated electronic miscellaneous document (EMD-A) can be issued for an ancillary service, such as excess checked baggage, sports equipment, premium seats, or a meal or beverage. An associated electronic miscellaneous document is directly associated to a flight coupon for a flight segment.

A travel provider, such as an airline, may not be able to deliver one or more of the ancillary services as initially planned. In addition, a flight disruption may prompt changes to a flight ticket to which one or more electronic miscellaneous documents are also associated. Such involuntary changes, which are not requested by the customer, involve a modification of the original electronic miscellaneous documents issued for the customer. Agencies in charge of the issuance of electronic miscellaneous documents should ensure that the customer will not be impacted by such involuntary changes. As an accommodation to the customer, an agent may issue a new electronic miscellaneous document providing for a new service or a similar service on a different flight and without any additional fee.

The new electronic miscellaneous document is manually issued through a series of time-consuming, complex, and error-prone operations to create a new record containing a reference to the original document and information about the new service, while also indicating that the customer has already paid and that no additional amount is due. The modifications to the original electronic miscellaneous document are generally performed under tense circumstances (e.g., a flight disruption, a customer that is dissatisfied because of an unexpected change to a flight ticket, etc.) and potentially along with a large number of similar modifications for other customers.

The re-pricing of an electronic miscellaneous document is relatively complex in comparison with the re-pricing of a flight ticket. One of the reasons is that the price of a new electronic miscellaneous document depends, among other parameters, on the price of the related flight ticket.

Improved methods, systems, and computer program products are needed to handle exchanges of electronic miscellaneous documents in response to involuntary modifications of services.

### SUMMARY

Embodiments of the invention generally comprise methods, systems, and computer program products for responding to a change in an airline reservation. A request, which includes first data for a passenger name record, is received for the change to the airline reservation. Second data for an electronic miscellaneous document that is linked to the first data for the passenger name record is also received. A determination is made as to whether the electronic miscellaneous document can be exchanged by applying at least one exchange eligibility rule to the first data for the passenger name record and the second data for the electronic miscellaneous document. If the electronic miscellaneous document can be exchanged, an exchange of the electronic miscellaneous document is automatically processed.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a diagrammatic view of an exemplary operating environment including a plurality of computer systems.

FIG. 2 is a diagrammatic view of an exemplary computer system of FIG. 1.

FIG. 3 is a block diagram of an exemplary service changer system in accordance with an embodiment of the present invention.

FIGS. 4A and 4B are a flow chart of the steps performed at the input analyzer component in accordance with an embodiment of the invention.

FIG. 5 is a flow chart for a process performed at the involuntary case management component in accordance with an embodiment of the invention.

FIG. 6 is a sequence diagram in accordance with an embodiment of the invention.

FIG. 7 illustrates the data provided by the different components and databases for the determination of a new pricing record.

FIG. 8 illustrates a passenger name record before an involuntary change rebooking and after the involuntary change rebooking.

FIGS. 9A and 9B illustrate an electronic miscellaneous document before a voluntary change rebooking and after the voluntary change rebooking that is associated to the passenger name record of FIG. 8.

### DETAILED DESCRIPTION

Embodiments of the invention are generally directed to systems, methods, and computer program products to automatically handle the updating of electronic miscellaneous document in response to involuntary changes to ancillary services and/or an involuntary change to a flight ticket to which an ancillary service is associated. The service changer system may perform complex transactions by collecting data from a variety of sources, adapting and aggregating the data into a single record to simultaneously process in a single query one or more changes of electronic miscellaneous documents for several passengers. The service changer system provides a flexible layout within a user graphical user interface that permits the services impacted by the changes to be identified and the related documents to be exchanged. In response to different scenarios characterized by multiple changes to one or more electronic miscellaneous documents, the service changer system can trigger different processes adapted to each specific scenario. The service changer system may identify and handle use cases prompted by flight disruptions that may lead to a re-association process to handle the electronic miscellaneous document instead of an exchange process.

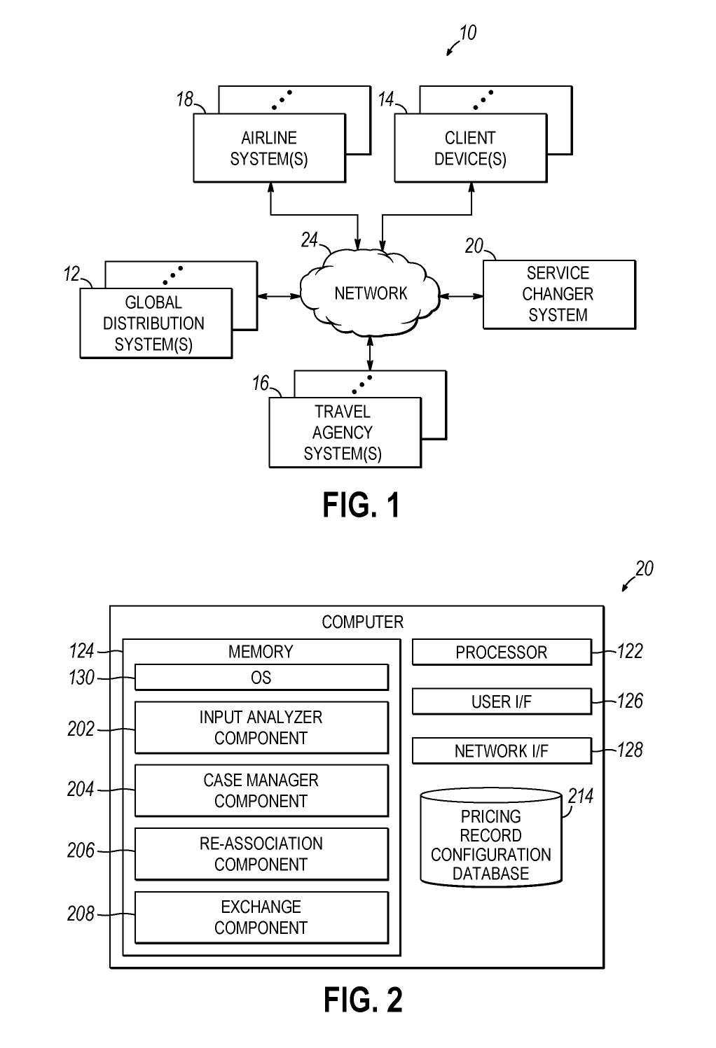

With reference to FIG. 1, an operating environment 10 may include one or more global distribution systems (GDS) 12, one or more client devices 14, one or more travel agency systems 16 constituting indirect seller systems, one or more airline systems 18 constituting carrier systems, and a service changer system 20. The GDSs 12, client devices 14, travel agency systems 16, airline systems 18, and service changer system 20 may be coupled to a network 24. The network 24 may include one or more private and/or public networks (e.g., the Internet) that enable the exchange of data.

Each GDS 12 may be configured to facilitate communication between the travel agency systems 16 and the airline systems 18 by enabling travel agents, validating carriers, or other indirect sellers to search for available travel products and book reservations on one or more of the airline systems 18 via the GDS 12. To this end, each GDS 12 may maintain a communication link to each airline systems 18 via the communication network 24. These communication links may allow the GDS 12 to obtain scheduling and availability data for travel products from the airline systems 18. Each travel agency system 16 may thereby book flights, as well as trains, hotels, rental cars, or other services, from multiple service providers via a single connection to the GDS 12.

In response to a travel product being booked, the GDS 12 may receive and store information about the travel product in a passenger name record (PNR). The PNR may be generated, at least in part, by the airline systems 18, and may comprise one or more reservation records comprised of segments and traveler data associated with one or more booked reservations. PNR segments may be identified, for example, as active (e.g., for a service yet to be provided by the corresponding service provider), passive (e.g., for a service reserved in another system or provided by a third party), past date, flown, information, open (e.g., for a purchased service having an open date), or canceled. The PNR may be stored in a database accessible to GDSs 12, airline systems 18, travel agency systems 16, and service changer system 20. The PNR may be identified by a record locator unique to each PNR, and may include segments defining an itinerary for a particular trip, service, passenger, or group of passengers. The itinerary may include services from multiple carriers (e.g., flights, bus, and or rail segments), hotel reservations, rental car reservations, or any other travel-related services.

Each airline system 18 may include a computer reservation system (CRS) and/or billing system for the respective service provider. The CRS may enable each GDS 12 and/or each travel agency system 16 to reserve ticketed services, such as flights, rail services, hotel rooms, or rental cars, as well as ancillary services associated with the ticketed services. Each airline may own and operate airport ticket offices (ATO) and city ticket offices (CTO) to sell tickets for themselves and/or other airlines. The airline systems 18 may each include a reservation system that enables airline ticketing offices, the GDSs 12, and/or the travel agency systems 16 to find, book, and pay for airline tickets.

Each travel agency system 16 may include a server application, such as a web server, that provides a publicly accessible website. This website may be configured to provide access to travel planning features, such as the ability to search for travel products matching a travel request. To this end, each travel agency system 16 may be configured to provide the traveler with access to data from one or more databases hosted by the GDS 12, travel agency systems 16, and/or airline systems 18.

Each client device 14 may be any suitable computing system configured to communicate over the network 24. Each client device 14 may comprise a desktop, laptop, or tablet computer, a smart phone, a personal digital assistant, or any other mobile or fixed computing device that enables the traveler to search for and book travel services over the network 24. For example, each client device 14 may include a client application, such as a web-browser, that communicates with a server application hosted by one of the travel agency systems 16, such as a web-server. The server application may, in turn, communicate with the GDS 12, travel agency systems 16, and/or airline systems 18 to obtain data relating to available travel services so that a traveler may book travel services and be issued electronic documents.

The GDS 12 may access one or more document databases to store and retrieve data relating to electronic tickets or other electronic documents associated with a purchased service. The service changer system 20, which may be hosted by, e.g., a GDS 12 or an airline system 18, may be configured to handle the exchange of electronic miscellaneous documents (EMDs) in response to voluntary passenger modifications to a reservation. The service changer system 20 may be provided by an airline IT solution provider that also provides a network infrastructure for the operating environment 10, and that may offer, among others, hardware and software components for online transactions involving sales tickets and ancillary services. All or a portion of the service changer system 20 may be integrated into one or more of the other systems, such as one of the GDSs 12.

Each EMD may comprise one or more electronic coupons stored in a document database accessible to at least the service changer system 20, with each coupon corresponding to a service provided by the EMD. In response to one or more of the electronic coupons being used, exchanged, or refunded, the document database may be updated to reflect a change in status of the electronic document.

FIG. 2 provides a block diagram that illustrates the components of the one or more servers of a computer system that may comprise the service changer system 20 in accordance with an embodiment of the invention. The service changer system 20 may receive and process a request for an involuntary change to an EMD that is generated and triggered by an airline in response to the occurrence of an unexpected external factor and without consultation with the traveler.

The service changer system 20 includes at least one processor 122 including at least one hardware-based microprocessor and a memory 124 coupled to the at least one processor 122. The memory 124 may represent the random access memory (RAM) comprising the main storage of the service changer system 20, as well as any supplemental levels of memory, e.g., cache memories, non-volatile or backup memories (e.g., programmable or flash memories), read-only memories, etc. In addition, memory 124 may be considered to include memory storage physically located elsewhere in the service changer system 20, e.g., any cache memory in a microprocessor, as well as any storage capacity used as a virtual memory, e.g., as stored on a mass storage device or on another computer coupled to the service changer system 20.

For interface with a user or operator, the service changer system 20 may include a user interface 126 incorporating one or more user input/output devices, e.g., a keyboard, a pointing device, a display, a printer, etc. Otherwise, data may be communicated to and from another computer or terminal (e.g., GDSs 12, client devices 14, travel agency systems 16, and airline systems 18) over a network interface 128 coupled to the communication network 24. The service changer system 20 also may be in communication with one or more mass storage devices, which may be, for example, internal hard disk storage devices, external hard disk storage devices, external databases, storage area network devices, etc.

The service changer system 20 typically operates under the control of an operating system 130 and executes or otherwise relies upon various computer software applications, components, programs, objects, modules, engines, data structures, etc. In particular, the components may include an input analyzer component 202, a case manager component 204, an EMD re-association component 206, an EMD exchange component 208, and a pricing engine 216, and may comprise instructions that may be resident and/or stored in the memory 124.

The service changer system 20 may include one or more databases including, for example, a pricing record configuration database 214. The database 214 may comprise data and supporting data structures that store and organize the data. In particular, the database 214 may be arranged with any database organization and/or structure including, but not limited to, a relational database, a hierarchical database, a network database, and/or combinations thereof. A database management system in the form of a computer software application executing as instructions on the processing unit of the service changer system 20 may be used to access the information or data stored in records of the database 214 in response to a database query.

Moreover, various applications, components, programs, objects, modules, engines etc. may also execute on one or more processors in another computer coupled to the service changer system 20 via the communication network 24, e.g., in a distributed or client-server computing environment, whereby the processing required to implement the functions of a computer program may be allocated to multiple computers over a network. For example, some of the functionality described herein as being incorporated into the service changer system 20 and/or components of the service changer system 20 may be implemented in one or more servers. Consistent with embodiments of the invention, the modules, applications, components and/or engines may be executing on one or more servers of the service changer system 20, and may cause the processor 122 of the service changer system 20 to perform operations consistent with embodiments of the invention.

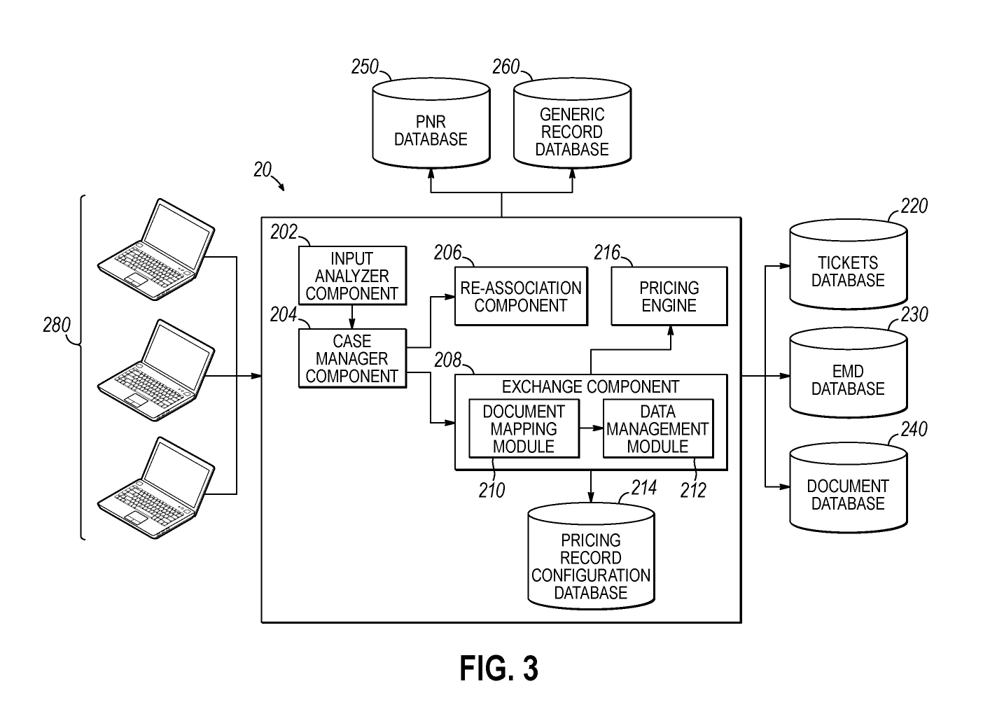

FIG. 3 depicts a block diagram of the service changer system 20 in accordance with an embodiment of the invention. The service changer system 20 performs all the operations of handling an involuntary service change. Each involuntary service change covers the case in which a traveler has no choice over the change(s) and the airline initiates the change(s). An involuntary service change may be generated after the occurrence of an unexpected external factor that forces the airline to change the EMDs. Involuntary changes may be, for example, the result of a flight cancellation, a schedule change, a flight delay, or another type of flight disruption. An involuntary change request may be triggered either by a direct or an indirect channel, i.e., airline websites, cryptic terminals, GUI terminals, GDS, or travel agent, or by another system capable of automatically handing disruption cases, all shown as client terminals 280. The service changer system 20 is coupled to various components having a variety of databases to store documents involved in the process, such as electronic tickets stored in a ticket database 220, EMDs stored in a EMD database 230, and generic documents stored in a document database 240, as well as information regarding reservations in the form of PNRs stored in a PNR database 250 or records of other types stored in a generic record database 260. The databases 220, 230, 240, 250, 260 may be similar in organization and structure to the pricing record configuration database 214. The databases 220, 230, 240, 250, 260 may be hosted at one or more of the GDSs 12 and/or airline systems 18.

Each EMD stored in the EMD database 230 is an electronic document that may be issued in response to a traveler purchasing an ancillary service. The EMD can be consulted to determine whether the traveler is entitled to receive the ancillary service. Exemplary services for which EMDs may be issued include allowances to carry additional luggage, entitlements to enter special zones (e.g., a business lounge), receive a meal or a beverage during a travel segment (e.g., a flight), choose a specific seat (e.g., a window seat, an aisle seat, a seat with extra leg room, etc.), receive transportation services between an airport and a hotel, or receive premium in-flight services.

Each PNR stored in the PNR database 250 may include traveler data that provides details of a traveler's reservation, other data related to the traveler's trip, and data that assists airline personnel with passenger handling. Specific data typically found in the PNR may include the name of the traveler, a passenger type code, data identifying one or more reserved travel segments, contact information for the traveler, when and where tickets are to be issued, and the ticketing office or agent that made or updated the reservation. When an EMD is issued for an ancillary service, the PNR may be updated with data that associates the PNR with the EMD. The travel service provider may thereby associate the segments in the PNR with the EMD for the corresponding ancillary service purchased by the traveler.

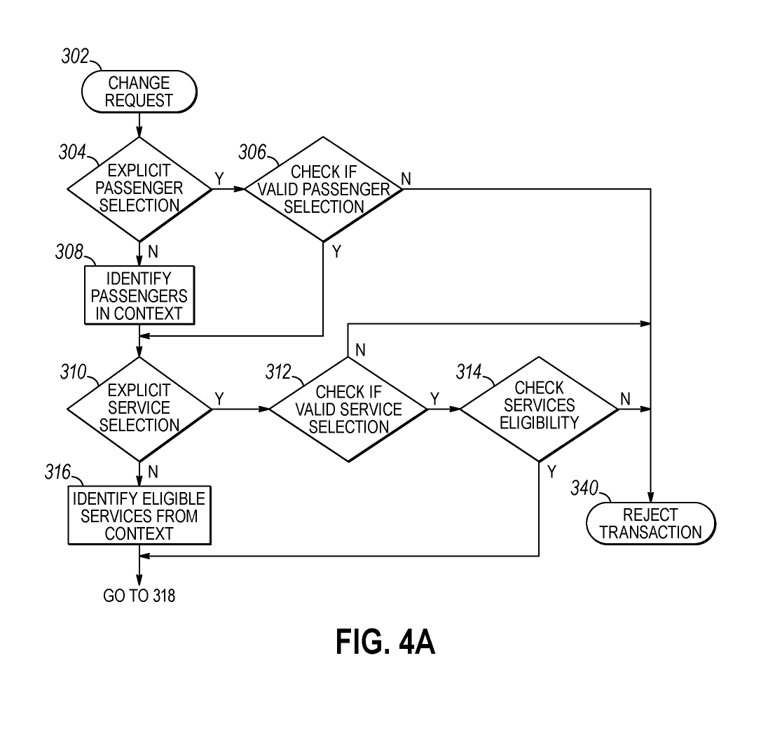

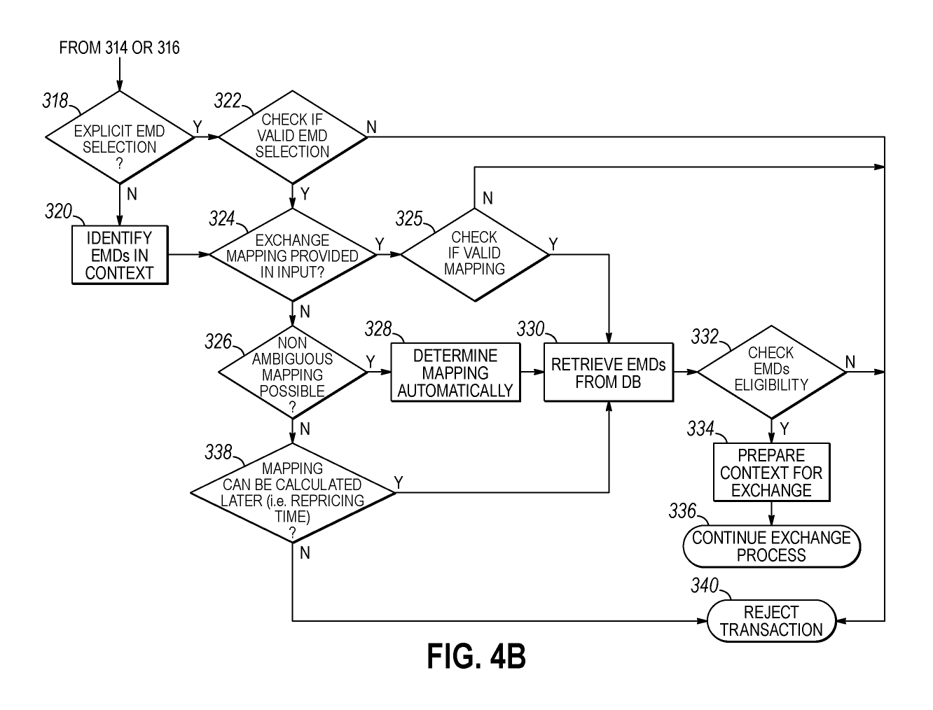

The service changer system 20 includes an input analyzer component 202 for verifying the validity of an involuntary change request. The request to be processed may require performing one or more exchanges, each exchange from one or more EMDs to one or more services for a given passenger. The information on the services to be included in the exchange can be either explicitly selected by the agent or, if not entered, can be automatically identified from the context of the request (i.e., by inference from an automatic analysis of associations between the elements in the request). After a validity checking process detailed below in connection with FIGS. 4A and 4B, the involuntary change request is further processed by a case manager component 204 of the service changer system 20.

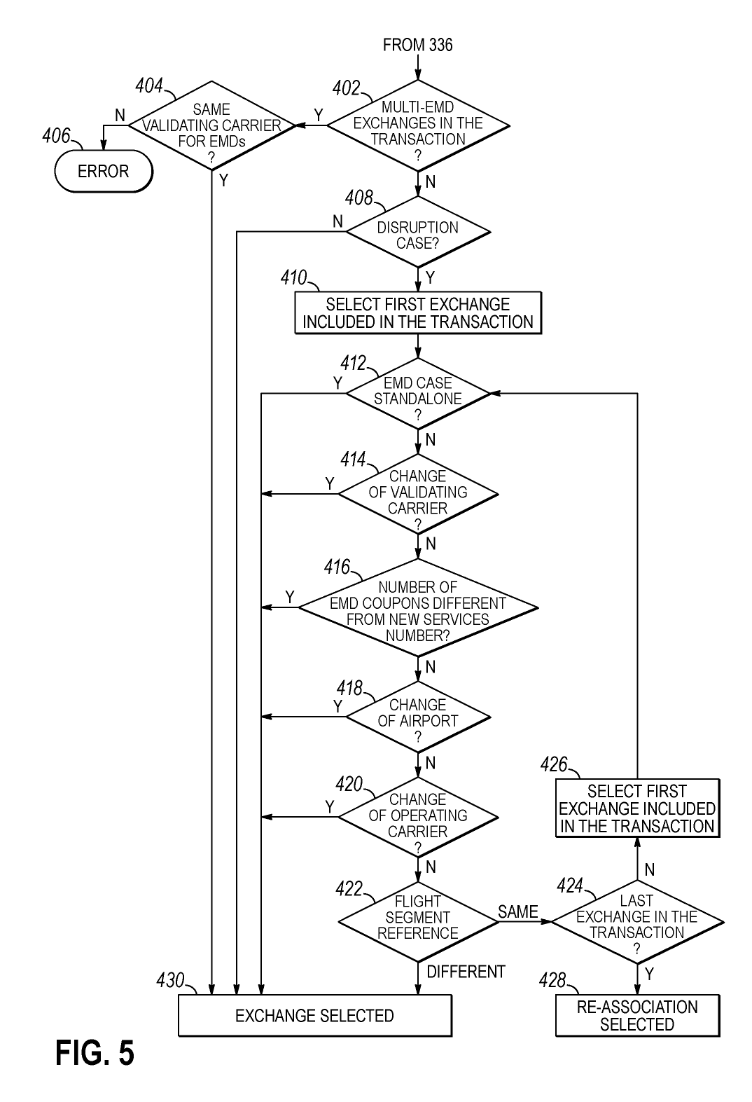

The case manager component 204 is in charge of verifying a set of requirements in order to identify the outcome of the transaction and to determine whether the EMD is to be exchanged with a new EMD or if the existing EMD is to be updated. The determination process is further discussed below with reference to FIG. 5. The output from the case manager component 204 is then input to either the EMD re-association component 206 of the service changer system 20 or to the EMD exchange component 208 of the service changer system 20.

The EMD re-association component 206 handles the operations of associating an existing EMD subject to the involuntary service change with a new element generated by the involuntary service change. The EMD re-association component 206 prepares the PNR for the current re-association of the EMD, for example, by creating links between the new rebooked service elements and the fare elements in the PNR representing the EMD to exchange.

The EMD exchange component 208 handles the operations for generating a new EMD that combines data from the original EMD and data associated with the new rebooked services. The EMD exchange component 208 includes a document mapping module 210 for selecting the data from the original EMD that must be kept in the new record, and a data management module 212 for aggregating the selected data with all information specific to the new service(s), such as data extracted from the PNR and pricing information.

The EMD exchange component 208 is further coupled to a pricing record configuration database 214 and a pricing engine 216 of the service changer system 20. The pricing record configuration database 214 stores pricing record configurations, which allows the creation of a pricing record in conformity with defined airline rules because all or part of the data for the new EMD may depend on specific airline rules. The pricing engine 216 provides all specific fare data to allow the passenger to not be charged for the new services. The EMD output from the service changer system 20 is further stored in the EMD database 230.

FIGS. 4A and 4B show a process flow performed at the input analyzer component 202 in accordance with an embodiment of the invention. An involuntary change request is received by the service changer system 20 in block 302. All data required for the exchange process is gathered, including information on passengers and services impacted by the involuntary change. As described above, the input analyzer component 202 is in charge of verifying the validity of the requested exchange. The process automatically retrieves the missing information (through blocks 308, 316, 320, 328 of the process flow) if the change request does not define all the elements involved for the exchange.

After the receipt of the involuntary change request, the service changer system 20 determines in block 304 whether all the passengers for which the exchange has to be performed are identified in the request by appropriate passenger selections from the agent. If the passenger selections are clearly mentioned (branch Yes), the validity of the selection of passengers is checked in block 306. For example, if the passenger exists in the context and if the request is coherent in general with this context (e.g., in the request it is mentioned “pax infant 1” and if “pax 1” exists but for an adult), then the check fails. If the passenger selections are not valid, the service changer system 20 rejects the transaction (block 340). Otherwise, control is transferred by the service changer system 20 to block 310.

If the passenger selections are not mentioned in the request (branch No in block 304), all the passengers involved in the current context of the change are automatically retrieved by the service changer system 20 in block 308. Following the blocks (304, 306, 308) pertaining to the identification of the passengers, the validity of the change request is checked by the service changer system 20 at a services level by controlling several eligibility criteria.

In block 310, the service changer system 20 checks to determine whether new services are mentioned in the request. If new services are mentioned, the service changer system 20 checks the validity of the services selections in the request, i.e., if the service exists in the context or if it is associated with the selected passenger (block 312). If the services selections are not valid, the service changer system 20 rejects the transaction (block 340). Otherwise, the service changer system 20 transfers control to block 314.

In block 314, the eligibility of the selected services to involuntary changes is checked. If the services are not valid, the transaction is rejected (block 340). Otherwise, the service changer system 20 transfers control to block 318. Eligibility may be defined through several rules determining which services can be targeted by an exchange and which services cannot be targeted by an exchange. For instance, all of the ancillary services that cannot be priced may be excluded from exchange. Another eligibility rule can be based on the date of the ancillary service, where, for example, past-dated services are excluded from the exchange.

If the ancillary services are not explicitly selected in the request in block 310, the predefined eligibility criteria are used to filter services in the PNR, in order to discard the non-eligible services from the exchange process (block 316). Control is transferred by the service changer system 20 to block 318 as illustrated on FIG. 4B.

In block 318, a determination is made by the service changer system 20 whether the EMD(s) is/are explicitly defined in the request. If the EMD(s) is/are explicitly defined in the request, the service changer system 20 checks the validity of the EMD selections in the request (block 322). For example, the service changer system 20 checks whether the selection is done by a reference in the PNR. If the selection exists and corresponds to an EMD, or if the selection is an EMD number, then the service changer system 20 checks for the existence of the selection in the EMD database 230. If the EMD selections are not valid, the transaction is rejected (block 340). Otherwise, the service changer system 20 transfers control to block 324.

In block 324, the service changer system 20 performs a test to check whether the request provides a mapping between documents and services. For example, the mapping in the request may contain two separate lists, one with the EMDS and one the services, or may contain a list of associations between EMD and services like “EMD1-SRV1-2, EMD2-SRV3-4”.

If the EMD(s) is/are not explicitly defined or mentioned in the request in block 318, all the EMDs involved in the current context of the change are automatically identified by the service changer system 20 and retrieved by the service changer system 20 in block 320. The service changer system 20 transfers control to block 324.

In block 324, if the service changer system 20 does not find a mapping in the request, the service changer system 20 transfers control to block 326. Otherwise, in block 325, the service changer system 20 performs a test to determine the validity of the mapping. If the mapping is not valid, the transaction is rejected (block 340). For example, several services can be requested to be included in the same exchange but, if these services don't have the same RFIC code, these services cannot be in the same pricing record, and the mapping is considered invalid. If the mapping is valid, the service changer system 20 transfers control to block 330.

If a mapping document is not provided in the input request received in block 326, the service changer system 20 determines its own mapping between EMDs and services mainly on the basis of passenger association. The service changer system 20 performs a test to determine whether a single mapping document can be selected for the current change context. If a single mapping document cannot be selected, the service changer system 20 transfers control to block 338 to determine whether the mapping operation can be determined at later stage of the exchange process. This could be the case, for example, if it is not possible to infer all exchanges from the PNR and have the pricing engines provide a feature to calculate the mapping based on amount balances. If the mapping cannot be postponed, the transaction is rejected (block 340); otherwise, the service changer system 20 transfers control to block 330.

If the test in block 326 does provide a single mapping document as the result, the service changer system 20 automatically determines the mapping document to be applied to the exchange request (block 328). In block 330, the service changer system 20 automatically retrieves the EMDs to be selected for the involuntary change request from the EMD database 230.

In block 332, the service changer system 20 performs a test to check the eligibility of each EMD retrieved in block 330 based on the predefined eligibility rules. For example, an EMD that has a coupon already on exchanged or reissued status is not eligible to current request of involuntary exchange. For an EMD that is not eligible, the transaction is rejected (block 340); otherwise, for eligible EMDs, the service changer system 20 transfers control to block 334. In block 334, the service changer system 20 prepares an updated PNR for each passenger. For instance, if previous pricing records are present in the existing PNR for the rebooked services, they are deleted. After the updated PNR is prepared for each passenger, the exchange process is continued in block 336.

FIG. 5 shows a flow chart of an embodiment of the process performed at the case manager component 204. The case manager component 204 determines whether the existing EMD is to be exchanged with a new one or is to be updated by a re-association operation.

The process begins when an involuntary change request is received by the input analyzer component 202. In block 402, a determination is made by the case manager component 204 whether there are multiple EMD exchanges in the transaction. If multiple EMD exchanges are involved in the transaction, the process goes to step 404 to determine if, for each EMD exchange, all EMDs involved in the exchange are handled by the same validating carrier. If all EMDs involved in the exchange are not handled by the same validating carrier, the process ends with an error and rejection of the transaction (block 406). Otherwise, control is transferred by the case manager component 204 to block 430 to select an exchange operation to be handled by the EMD exchange component 208.

If multiple EMD exchanges are not involved in the transaction, the case manager component 204 determines whether the exchange is in the context of a flight disruption indicated in the request (block 408). If the EMD exchange is not the result of a flight disruption, then control is transferred by the case manager component 204 to block 430 to select an exchange operation to be handled by the EMD exchange component 208.

If the EMD exchanges are the result of a flight disruption, the first EMD of the request is selected by the case manager component 204 (block 410) and the case manager component 204 determines whether the type of the EMD is a standalone EMD-S (block 412). If the EMD is an EMD-S, control is transferred by the case manager component 204 to block 430 to validate an exchange operation. Otherwise (e.g., for an EMD-A), the case manager component 204 checks whether there is a change in the validating carrier (block 414). If the validating carrier does not change, then control is transferred by the case manager component 204 to block 430 to select an exchange operation to be handled by the EMD exchange component 208.

If the validating carrier is unchanged, the case manager component 204 compares the number of EMD coupons with the number of new services in the request (block 416). If the comparison indicates that the numbers differ, then control is transferred by the case manager component 204 to block 430 to select an exchange operation to be handled by the EMD exchange component 208.

If the numbers do not differ, the case manager component 204 determines whether there is a change in the airport (block 418). If the airport changes, then control is transferred by the case manager component 204 to block 430 to select an exchange operation to be handled by the EMD exchange component 208.

If the airport does not change, then the case manager component 204 determines whether there is a change in the operating carrier (block 420). If the operating carrier changes, then control is transferred by the case manager component 204 to block 430 to select an exchange operation to be handled by the EMD exchange component 208.

If the operating carrier does not change, the case manager component 204 compares the reference of the flight segments (block 422). If the flight segment reference changes, then control is transferred by the case manager component 204 to block 430 to select an exchange operation to be handled by the EMD exchange component 208.

If the flight segment reference does not change, the case manager component 204 determines whether the last EMD exchange is processed (block 424). If the last EMD exchange has not been processed, the case manager component 204 determines whether selects the next EMD in block 426 and control is transferred to block 412. If the last EMD exchange has been processed, the case manager component 204 selects a re-association operation to be handled by the EMD re-association component 206 (block 428).

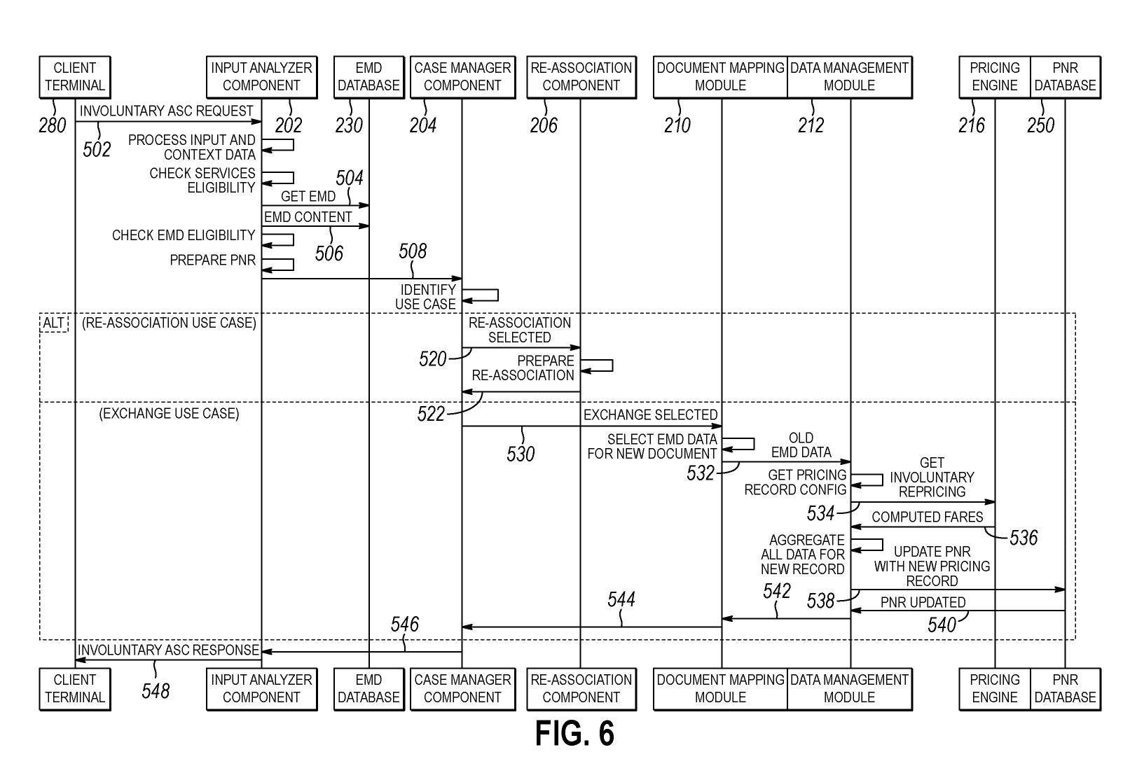

FIG. 6 is a sequence diagram illustrating the data flow between the components in accordance with an embodiment of the invention. The input analyzer component receives a request for an involuntary services change in message 502. The content of the request is analyzed and the eligibility of the new services requested is determined as detailed with reference to FIG. 4A.

The input analyzer component 202 queries the EMD database 230 to retrieve the EMD corresponding to the request in message 504. The EMD is received by the input analyzer component in message 506. In response to receipt of the EMD, the input analyzer component 202 finalizes the overall request checking process as described in FIG. 4B and prepares the PNR for pursuing the process.

The input analyzer component 202 provides the data in message 508 to the case manager component 204, which is in charge of determining which sub-process applies to the current case, either an EMD re-association or an EMD exchange as detailed with reference to FIG. 5.

In the event of an EMD re-association, the case manager component 204 queries the EMD re-association component 206 in message 520 with a request to prepare the PNR data and the various links for the re-association. The EMD re-association component 206 communicates the PNR data and the various links to the case manager component 204 in a message 522.

In the event of an EMD exchange, the case manager component 204 queries the document mapping module 210 in message 530 to select those data from the current EMD to be imported in the new EMD. In response, the document mapping module 210 provides the selected old data in message 532 to the data management module 212, which is in charge of aggregating all data, old and new, data from the current PNR context, data for the specific configuration, and data from the pricing engine 216. To receive all of the data, the data management module 212 queries the pricing engine 216 in message 534 to compute the fares. The pricing engine 216 replies in message 536 to return the computed values for fares to the data management module 212. Due to the involuntary character of the transaction, the total fare of the new record is set to zero, because the customer does not pay any additional collection for rebooked services. All pricing data that will be part of the new record and that are particular to involuntary exchange transaction are computed at this point. After receiving the fare computation, the data management module 212 has access to all data to fill a new pricing record 500 from which the reissued EMD will be generated.

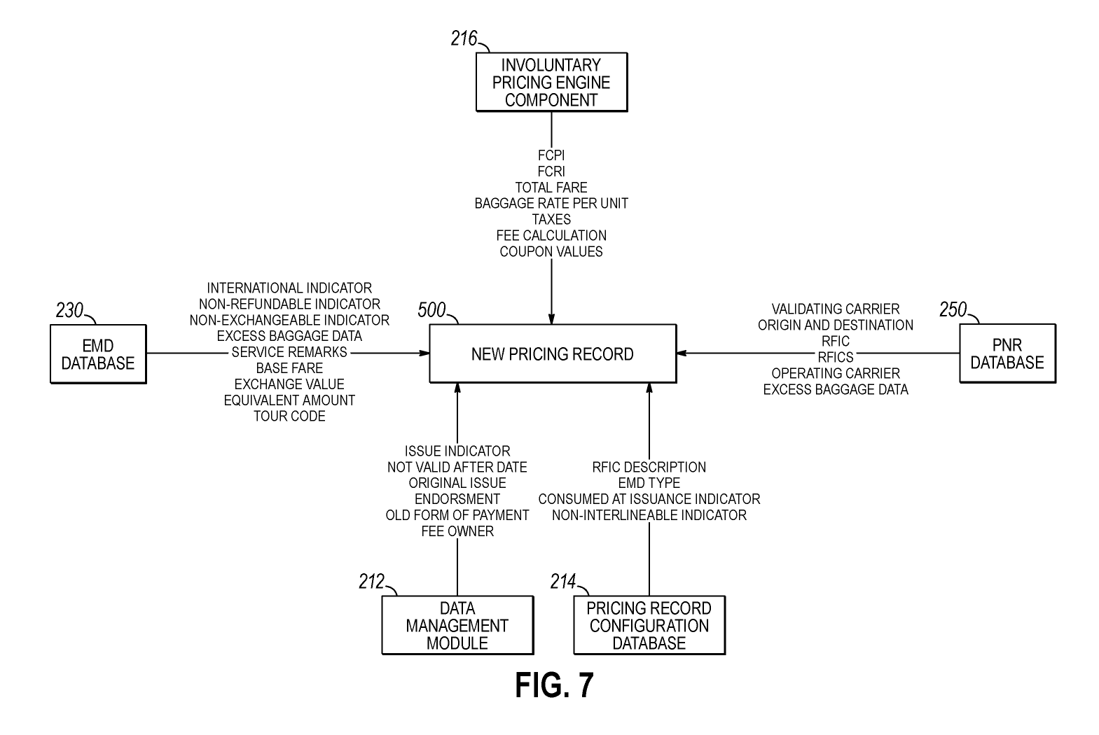

The PNR database 250 is updated in message 538 with the new pricing record and the updated PNR is confirmed in message 540. FIG. 7 illustrates the data provided by the different components and databases for the creation of the new pricing record 500.

The updated PNR is provided to the document mapping module 210 in message 542. The document mapping module 210 replies in message 544 by returning all data to the case manager component 204.

The involuntary change process ends by sending in message 546 to the input analyzer component 202 the data, specifically either the data from the re-association process or the data from the exchange process. The result of the involuntary change process to the initial request is communicated to the client terminal in message 548.

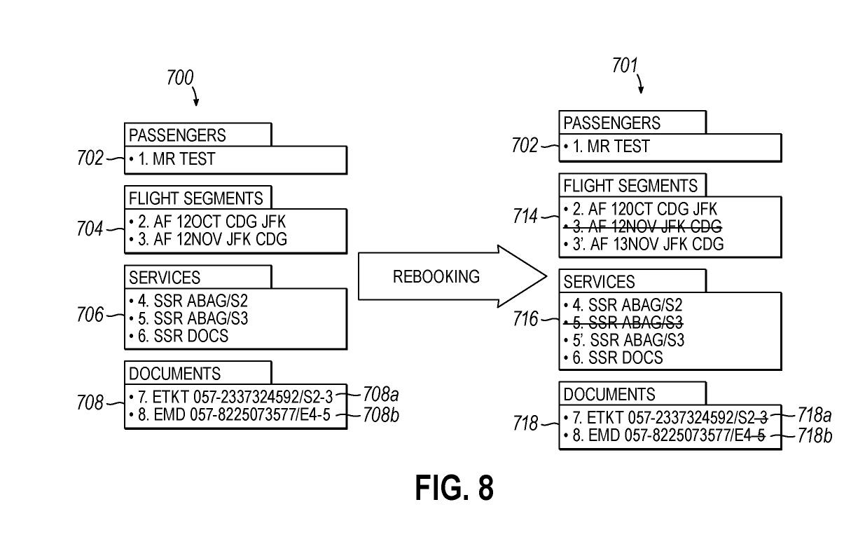

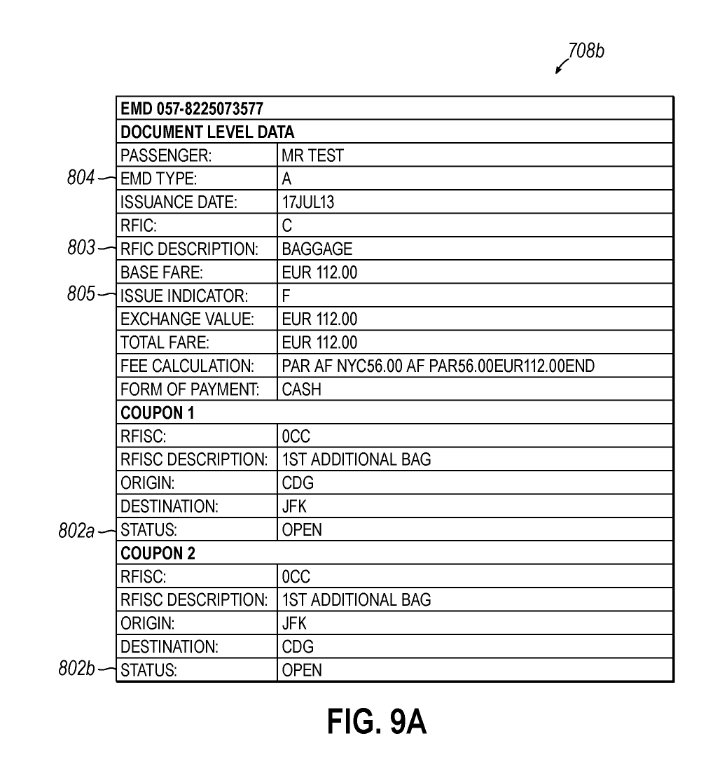

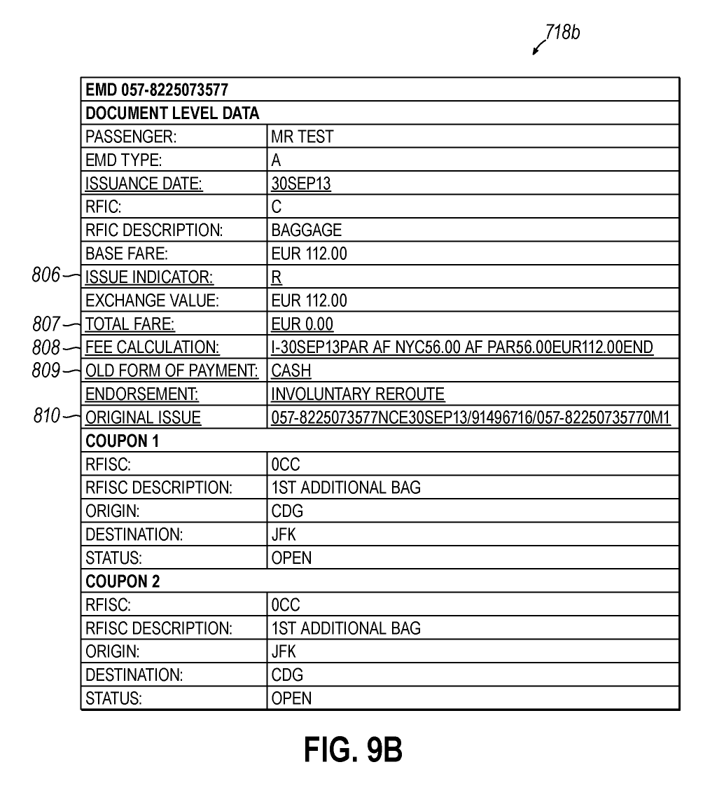

Reference is now made to FIG. 8 which illustrates an exemplary PNR before and after rebooking prompted by an involuntary change and to FIGS. 9A, 9B which illustrate an exemplary EMD 708b before an involuntary change rebooking associated to the PNR of FIG. 8 and an exemplary EMD 718b after an involuntary change rebooking associated to the PNR of FIG. 8.

Before the involuntary change request resulting in rebooking, the fields or parts of a PNR 700 (FIG. 8) include a passenger 702 (1.Mr. Test) who is reserved with flight segments 704 on a flight from Paris to New York on October 12 (2.AF 12OCT CDG JFK), with a return on November 12 (3.AF 12NOV JFK CDG). Ancillary services 706 are requested for an additional baggage for the whole itinerary (4.SSR ABAG/S2 and 5.SSR ABAG/S3). The documents 708 generated for Mr. Test's booking are an e-ticket 708a (7.ETKT 057-2337324592/S2-3) for the flight and an EMD 708b (EMD 057-822073577/E4-5) for the services.

In the exemplary scenario, the airline decides for commercial reasons to cancel the New York/Paris flight of November 12 purchased by Mr. Test. As a consequence, an airline agent needs to rebook a different flight for the customer on a different day, such as November 13. The old flight and the service associated with the New York/Paris flight of November 12 are deleted from Mr. Test's reservation and replaced by a new flight 714 (3′.AF 13NOV JFK CDG) with a different date (November 13) and a new additional service 716 (5′.SSR ABAG/S3) for the baggage associated with this flight. Other documents remain valid, but they only apply to the portion of the itinerary that has not been rebooked. The agent has to exchange the old documents associated with the new reservation.

The agent from his or her client terminal 280 (e.g., a cryptic terminal) displays the PNR of the customer as rebooked with the new itinerary. The agent sends an EMD exchange request using, for example, a cryptic command ‘FXI/EMD’ with no parameters explicitly selected. The current PNR context is taken into account in the request. As already detailed, the input analyzer component 202 processes the context to identify the following elements for the exchange. The passenger, (1.Mr TEST), is the only passenger in the PNR. The special service requests (SSRs) are (4.SSR ABAG/S2) and (5′.SSR ABAG/S3). While there is a third special service request in the PNR (6.SSR DOCS), this ancillary service is set as non-priceable and is considered non-eligible for exchange. Only one EMD (EMD 057-8225073577) is referenced in the PNR for passenger 1.

The data contained in the EMD is verified (message 504 in FIG. 6). The EMD database 230 is queried to retrieve the entire EMD document, which has its content analyzed content to determine the conditions for its eligibility. The coupon status is verified. In the example of FIG. 9A, the EMD includes two coupons 802a, 802b with an “open” status, which means that the EMD document is eligible for an exchange.

The next elements of Mr. Test's EMD exchange are to verify the constraints for a re-association as described with reference to FIG. 5. Because Mr. Test's EMD exchange is for the exchange of a single document, the condition (block 402 in FIG. 5) that a re-association does not apply to multiple EMD exchanges is confirmed. Because the agent did not mention a flight disruption in the request (i.e., the rebooking is a commercial choice of the airline), the condition (block 408 in FIG. 5) is satisfied that the Mr. Test's EMD exchange is not for a disruption and the exchange is proposed.

To obtain the complete record that will become the reissue EMD document, all needed data is either gathered or computed. The document mapping module 210 is in charge of retrieving the information related to the old EMD. For the example of Mr. Test's EMD exchange, the information provided includes an international indicator: I; a base fare: 112.00 EUR; and an exchange value: 112.00 EUR. The remainder of the old EMD data is provided as input to the data management module 212 for additional computations (as indicated by message 532 in FIG. 6).

As described hereinabove, the data management module 212 retrieves the configuration data for the considered service, i.e., the additional baggage ABAG. The configuration data may include an RFIC description 803, an EMD type 804, a consumed at issuance flag 805, and a non-interlineable indicator. For the example of Mr. Test's EMD exchange, the configuration data will include the RFIC description 803 is BAGGAGE, the EMD type 804 is “A” (i.e., flight associated), the consumed at issuance flag 805 is FALSE, and the non-interlineable indicator is FALSE.

The previously-retrieved EMD data is forwarded to the pricing engine 216 for the calculations specific to the involuntary change process. These calculations may include the computation of pricing data. For the example of Mr. Test's EMD exchange, the following pricing data are computed. The FCPI and FCRI flags are both set to ‘1’ to indicate that this calculation is considered manual (i.e., not performed by a standard pricing engine). Because no additional collection is due for an involuntary exchange, the total fare is set to ‘0.00 EUR’ expressed in reissue currency. The fee calculation is updated by adding an ‘I’ at the beginning to specify the involuntary character of the exchange and the date of exchange.

The remaining data to fill the new pricing record are computed by the data management module 212. For the example of Mr. Test's EMD exchange, the following data are computed: Issue indicator, R for reissue; a Not Valid After (NVA) date, in this case 17 Jul. 14; Original issue: contains the reference to exchanged EMD and coupons, as well as the exchange date, and IATA number of the office; Endorsement, INVOL REROUTE to specify that exchange is involuntary; Old form of payment, CASH because it was the form of payment of exchanged EMD; and Fee owner AF, calculated from the old EMD document.

The exchange is finalized by updating the context with the data representing all of the processed information (message 538 (FIG. 6)). Most of the data will be part of the new pricing record that will be used to generate the new EMD at issuance time. Some of the data (e.g., the original issue, the endorsement, or the old form of payment) can be stored in different elements of the PNR, but retain links to the main pricing record. All of these elements are created for the updated PNR and they will be available at issuance for the new document preparation. The documents 718 generated for Mr. Test's booking after the involuntary change are an e-ticket 718a for the flight and the EMD 718b for the services.

A response is returned to the agent to communicate the successful transaction. Then, the agent is able to check the output of the transaction and request the issuance of the new EMD without performing any other manual operation. FIG. 9B shows the new EMD issued for the described example with all modifications and repricing information updated. The repricing information includes a base fare 806, a exchange value 807, a total fare 808, and a fee calculation 809. The new EMD further includes a link with the original issue 810.

The service changer system 20 may offer an integrated solution, including all necessary checks of amounts and data, to allow that a transaction context is properly updated in order to provide agents and customers with clear visibility on the services being exchanged.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

The program code embodied in any of the applications/modules described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

These computer program instructions may also be stored in a computer readable medium that can direct a computer, other types of programmable data processing apparatus, or other devices to function in a particular manner, such that the instructions stored in the computer readable medium produce an article of manufacture including instructions that implement the function/act specified in the block or blocks of the flowchart and/or block diagram.

The computer program instructions may also be loaded onto a computer, other programmable data processing apparatus, or another device to cause a series of computations to be performed on the computer, the other processing apparatus, or the other device to produce a computer implemented process such that the executed instructions provide one or more processes for implementing the functions/acts specified in the flowchart and/or block diagram block or blocks.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the present invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method of responding to a change in an airline reservation, the method comprising:
receiving a request for the change to the airline reservation at a computer system, the request comprising first data for a passenger name record;
receiving, at the computer system, second data for a first electronic miscellaneous document that is linked to the first data for the passenger name record;
determining, by the computer system, whether the first electronic miscellaneous document can be exchanged by applying at least one exchange eligibility rule to the first data for the passenger name record and the second data for the first electronic miscellaneous document; and
if the first electronic miscellaneous document can be exchanged, automatically processing an exchange of the first electronic miscellaneous document with the computer system.

2. The method of claim 1 wherein receiving the second data for the first electronic miscellaneous document that is linked to the first data for the passenger name record comprises:
retrieving the second data for the first electronic miscellaneous document from an airline database.

3. The method of claim 1 wherein the first electronic miscellaneous document can be exchanged if the request includes a second electronic miscellaneous document, and the first and second electronic miscellaneous documents are handled by the same validating carrier.

4. The method of claim 1 wherein the first electronic miscellaneous document can be exchanged if the request does not include a second electronic miscellaneous document, and if the request does not include an indication of a flight disruption.

5. The method of claim 1 wherein the first electronic miscellaneous document can be exchanged if the request does not include a second electronic miscellaneous document, the request includes an indication of a flight disruption, and the first electronic miscellaneous document has a standalone designation, a validating carrier changes in the request, a number of coupons for services differs from a number of new services in the request, an airport changes in the request, an operating carrier changes in the request, or a flight segment reference is the same in the request.

6. The method of claim 1 wherein automatically processing the exchange with the computer system further comprises:
building a pricing record for a second electronic miscellaneous document.

7. The method of claim 6 wherein automatically processing the exchange further comprises:
updating the passenger name record with a link to the second electronic miscellaneous document.

8. The method of claim 7 wherein the passenger name record is updated without a fare computation by an external pricing engine.

9. The method of claim 6 wherein the pricing record is built by aggregating elements from the first data of the passenger name record, elements from the second data of the first electronic miscellaneous document, a fare received from an internal pricing engine, and third data computed by the automatic processing.

10. The method of claim 1 wherein a service is automatically identified from a context of the request if the service is not mentioned in the request.

11. A system for responding to a change in an airline reservation, the system comprising:
at least one processor; and
a memory coupled to the processor, the memory including program code configured to be executed by the at least one processor to cause the system to:
receive a request for the change to the airline reservation, the request comprising first data for a passenger name record;
receive second data for a first electronic miscellaneous document that is linked to the first data for the passenger name record;
determine whether the first electronic miscellaneous document can be exchanged by applying at least one exchange eligibility rule to the first data for the passenger name record and the second data for the first electronic miscellaneous document; and
automatically process an exchange of the first electronic miscellaneous document if the first electronic miscellaneous document can be exchanged.

12. The system of claim 11 wherein the program code is further configured to be executed by the at least one processor to cause the system to receive the second data for the first electronic miscellaneous document comprises:
program code configured to be executed by the at least one processor to cause the system to retrieve the second data for the first electronic miscellaneous document from an airline database.

13. The system of claim 11 wherein the first electronic miscellaneous document can be exchanged if the request includes a second electronic miscellaneous document, and the first and second electronic miscellaneous documents are handled by the same validating carrier.

14. The system of claim 11 wherein the first electronic miscellaneous document can be exchanged if the request does not include a second electronic miscellaneous document, and if the request does not include an indication of a flight disruption.

15. The system of claim 11 wherein the first electronic miscellaneous document can be exchanged if the request does not include a second electronic miscellaneous document, the request includes an indication of a flight disruption, and the first electronic miscellaneous document has a standalone designation, a validating carrier changes in the request, a number of coupons for services differs from a number of new services in the request, an airport changes in the request, an operating carrier changes in the request, or a flight segment reference is the same in the request.

16. The system of claim 11 wherein the program code is further configured to be executed by the at least one processor to cause the system to automatically process the exchange comprises:
program code configured to be executed by the at least one processor to cause the system to build a pricing record for a second electronic miscellaneous document.

17. The system of claim 16 wherein the program code is further configured to be executed by the at least one processor to cause the system to automatically process the exchange further comprises:
program code configured to be executed by the at least one processor to to cause the system update the passenger name record with a link to the second electronic miscellaneous document.

18. The system of claim 17 wherein the program code is configured to be executed by the at least one processor to cause the system to:
update the passenger name record without a fare computation by an external pricing engine.

19. The system of claim 16 wherein the program code is further configured to be executed by the at least one processor to cause system to:
build the pricing record by aggregating elements from the first data of the passenger name record, elements from the second data of the first electronic miscellaneous document, a fare received from an internal pricing engine, and third data computed by the automatic processing.

20. The system of claim 11 wherein the program code is further configured to be executed by the at least one processor to cause the system to:
automatically identify a service from a context of the request if the service is not mentioned in the request.

21. A computer program product comprising:
a non-transistory computer readable storage medium; and
program code stored on the computer readable storage medium and configured, upon execution, to cause at least one processor to:
receive a request for a change in an airline reservation, the request comprising first data for a passenger name record;
receive second data for a first electronic miscellaneous document that is linked to the first data for the passenger name record;
determine whether the first electronic miscellaneous document can be exchanged by applying at least one exchange eligibility rule to the first data for the passenger name record and the second data for the first electronic miscellaneous document; and
automatically process an exchange of the first electronic miscellaneous document if the first electronic miscellaneous document can be exchanged.
